(19) United States
(12) Patent Application Publication
(10) Pub. No.: US 2012/0047479 A1
(43) Pub. Date: Feb. 23, 2012

(54) Incremental Layout Analysis

(75) Inventors: James M. Paris, Portland, OR (US); Brian Marshall, Wilsonville, OR (US); John G. Ferguson, Tualatin, OR (US); Anant S. Adke, Lake Oswego, OR (US)

(73) Assignee: Mentor Graphics Corporation

(21) Appl. No.: 12/530,453

(22) PCT Filed: Mar. 9, 2008
(86) PCT No.: PCT/US2008/056356

§ 371 Date: Jul. 21, 2010

Related U.S. Application Data
(60) Provisional application No. 60/894,151, filed on Mar. 9, 2007.

(51) Int. Cl. G06F 17/50

(52) U.S. Cl. 716/112

(57) ABSTRACT

Techniques for incrementally analyzing layout design data are disclose. With various implementations, a subsequent incremental analysis can be made for only portions of layout design data, using a subset of available analysis criteria, or some combination of both. For example, the analysis can be limited to errors identified in a previous analysis process, to changes in the layout design data made after a previous analysis process, to particular areas specified by a designer, or some combination thereof. Still further, the analysis process may be performed using only a subset of analysis criteria relevant to the portions of the design data being analyzed, a subset of the initial analysis criteria that the design data failed in a previous analysis process, a subset of the initial analysis criteria selected by the designer, or some combination thereof. Further, such an incremental analysis process can be initiated before a previous analysis process has completed.

### RELATED APPLICATIONS

This application claims priority under 35 U.S.C. §119 to U.S. Provisional Patent Application No. 60/894,151, filed on Mar. 9, 2007, entitled “Incremental Design Rule Check,” and naming James Paris et al. as inventors, which provisional patent application is incorporated entirely herein by reference.

### FIELD OF THE INVENTION

The present invention is directed to the incremental analysis of layout design data. Various aspects of the invention may be particularly beneficial for analyzing changes in layout design data based upon results of a previous analysis, such as a design rule check analysis or a design-for-manufacturing analysis.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the structures that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place-and-route” tools), such as Mentor Graphics' IC Station or Cadence's Virtuoso, are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the regions where doping will (or will not) occur, while the geometric elements in the representation of a metal layer will define the locations in a metal layer where conductive wires will be formed to connect the circuit devices.

Still further, the layout design may be modified to take advantage of one or more resolution enhancement techniques (RET). These techniques improve the usable resolution of the reticle or mask created from the layout design in a photolithographic manufacturing process. One such type of modification process, sometimes referred to as an optical proximity correction (OPC) process, may add features, such as serifs or indentations, to existing layout design data in order to improve the resolution of a mask made from the modified layout design data. For example, an optical proximity correction process may modify a rectangular polygon to include a “hammerhead” shape that will decrease rounding of the photolithographic image at the corners of the polygon.

Typically, a designer will perform one or more processes to analyze the layout design data before it is finalized for creating a lithographic mask. For example, the layout design data may be analyzed to confirm that it accurately represents the circuit devices and their relationships as described in the device design. This type of analysis often is referred to as a “layout-verses-schematic check.” The layout design data also may be analyzed to confirm that it complies with various design requirements, such as providing a minimum spacing between geometric elements. This type of analysis commonly is referred to as a “design rule check.” Still further, the layout design may be analyzed to identify modifications that can be made to compensate for limitations in the manufacturing process. For example, a user may analyze the layout design data to determine if one or more of the geometric elements can be moved or changed so as to improve their manufacturability, or if redundant geometric elements can be added to the design as backup for geometric elements associated with a high probability of creating faults during a manufacturing process. This type of analysis commonly is referred to as a “design-for-manufacturing check” or a “lithographic-friendly-design check.” Similarly, after an optical proximity correction process, a designer may analyze the layout design data to determine whether any further enhancement modifications should be made.

Depending upon the results of an analysis process, a designer may modify the layout design data further. For example, if a design rule check analysis process identifies two geometric elements that are positioned too closely, then the designer may revise the layout design data by moving the geometric elements apart. Similarly, if a design-for-manufacturing analysis process identifies geometric elements that can be duplicated for redundancy (e.g., vias), then the designer may add one or more of the duplicate geometric elements to the design. After modifying the layout design data, the design may repeat one or more of the desired analysis processes, to ensure that the modifications have not created any new issues. This cycle of modification and analysis may be repeated a number of times, until the designer is satisfied with the results of the layout design data analysis (or analyses).

After the layout design has been finalized, it is converted into a format that can be employed by a mask or reticle writing tool to create a mask or reticle for use in a photolithographic manufacturing process. Masks and reticles typically are made using tools that expose a blank reticle or mask substrate to an electron or laser beam (or to an array of electron beams or laser beams). Most mask writing tools are able to only “write” certain kinds of polygons, however, such as right triangles, rectangles or other trapezoids. Moreover, the sizes of the polygons are limited physically by the maximum beam (or beam array) size available to the tool. Accordingly, larger geometric elements in the layout design, or geometric elements that are not right triangles, rectangles or trapezoids (which typically are a majority of the geometric elements in a layout design) must be “fractured” into the smaller, more basic polygons that can be written by the mask or reticle writing tool. This process sometimes is referred to as “mask data preparation.”

Once a layout design has been fractured into shots, then the fractured layout design data can be converted to a format compatible with the mask or reticle writing tool. Examples of such formats are MEBES, for raster scanning machines manufactured by ETEC, an Applied Materials Company, and various vector scan formats for Nuflare, JEOL, and Hitachi machines, such as VSB11 or VSB12. The written masks or reticles then can be used in a photolithographic process to expose selected areas of a wafer to light or other radiation in order to produce the desired integrated circuit devices on the wafer.

As noted above, a layout designer may repeat a cycle of analysis and modification a number of times. Many analysis processes, however, are time consuming and require a large amount of processing resources. Even using a distributed computing system, for example, running a single iteration of a design rule check process on a modern microprocessor design can take several hours. Moreover, with conventional design rule check techniques, a designer may need to run between ten to fifteen iterations of a design rule check process before the design is satisfactory. Further, designers anticipate that both microcircuit designs and the criteria used to analyze those designs will continue to become more complex in the future.

### BRIEF SUMMARY OF THE INVENTION

Aspects of the invention relate to techniques for incrementally analyzing layout design data. Some implementations of the invention may be particularly useful after a conventional analysis process has been initiated, where an entire set of layout design data is analyzed using a set of initial analysis criteria. With various examples of the invention, a subsequent incremental analysis can be made for only portions of the layout design data, using a subset of the analysis criteria, or some combination of both. For example, with some implementations of the invention, the analysis can be limited to errors identified in the initial (or other previous) analysis process, to changes in the layout design data made after the initial (or other previous) analysis process, to particular areas specified by a designer, or some combination thereof. Still further, some implementations of the invention may perform the analysis process using only the subset of the initial analysis criteria relevant to the portions of the design data being analyzed, the subset of the initial analysis criteria that the design data failed in the initial (or other previous) analysis process, a subset of the initial analysis criteria selected by the designer, or some combination thereof.

With various examples of the invention, an incremental analysis process (i.e., an analysis process using only selected portions of the initial layout design data, a subset of the initial analysis criteria, or both) can be initiated before the initial (or other previous) analysis process has completed. For example, a designer may employ an initial analysis process that provides real-time analysis results while the analysis process is continuing. When an error in the layout design data is identified, the designer can modify the design to correct the error. The designer can then initiate an incremental design process to confirm that the error has been corrected and/or that no new errors were created by the change, even while the layout design data continues to be analyzed by the initial analysis process.

### DETAILED DESCRIPTION OF THE INVENTION

### Organization of Layout Design Data

As used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single substrate. The layout design data may be in any desired format, such as, for example, the Graphic Data System II (GDSII) data format or the Open Artwork System Interchange Standard (OASIS) data format proposed by Semiconductor Equipment and Materials International (SEMI). Other formats include an open source format named Open Access, Milkyway by Synopsys, Inc., and EDDM by Mentor Graphics, Inc.

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells.

By categorizing microcircuit design data into hierarchical cells, large data structures can be processed more quickly and efficiently. For example, a circuit designer typically will analyze a design to ensure that each circuit feature described in the design complies with design rules specified by the foundry that will manufacture microcircuits from the design. With the above example, instead of having to analyze each feature in the entire 128 kB memory array, a design rule check process can analyze the features in a single bit cell. The results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

With various examples of the invention, layout design data will include two different types of data: “drawn layer” design data and “derived layer” design data. The drawn layer data describes geometric features that will be used to form structures in layers of material to produce the integrated circuit. The drawn layer data will usually include polygons that will be used to form structures in metal layers, diffusion layers, and polysilicon layers. The derived layers will then include features made up of combinations of drawn layer data and other derived layer data. For example, with the transistor gate described above, the derived layer design data describing the gate will be derived from the intersection of a polygon in the polysilicon material layer and a polygon in the diffusion material layer.

For example, a design rule check process performed by a design rule check module typically will perform two types of operations: “check” operations that confirm whether design data values comply with specified parameters, and “derivation” operations that create derived layer data. A transistor gate design data thus may be created by the following derivation operation:

gate=diff AND poly

The results of this operation will be a “layer” of data identifying all intersections of diffusion layer polygons with polysilicon layer polygons. Likewise, a p-type transistor gate, formed by doping the diffusion layer with n-type material, is identified by the following derivation operation:

pgate=nwell AND gate

The results of this operation then will be another “layer” of data identifying all transistor gates (i.e., intersections of diffusion layer polygons with polysilicon layer polygons) where the polygons in the diffusion layer have been doped with n-type material.

A check operation performed by a design rule check module will then define a parameter or a parameter range for a data design value. For example, a user may want to ensure that no metal wiring line is within a micron of another wiring line. This type of analysis may be performed by the following check operation:

external metal<1

The results of this operation will identify each polygon in the metal layer design data that are closer than one micron to another polygon in the metal layer design data.

Also, while the above operation employs drawn layer data, check operations may be performed on derived layer data as well. For example, if a user wanted to confirm that no transistor gate is located within one micron of another gate, the design rule check process might include the following check operation:

external gate<1

The results of this operation will identify all gate design data representing gates that are positioned less than one micron from another gate. It should be appreciated, however, that this check operation cannot be performed until a derivation operation identifying the gates from the drawn layer design data has been performed.

### Operating Environment

The disclosed technology includes all novel and unobvious features and aspects of the embodiments of the system and methods described herein both alone, and in various combinations and sub-combinations thereof. The disclosed features and aspects of the embodiments can be used alone or in various novel and unobvious combinations and sub-combinations with one another.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented in software stored on a computer-readable medium and executed on a computer. Some of the disclosed methods, for example, can be implemented as part of an electronic design automation (EDA) tool. Such methods can be executed on a single computer or a networked computer. For clarity, only those aspects of the software germane to these disclosed methods are described; product details well known in the art are omitted.

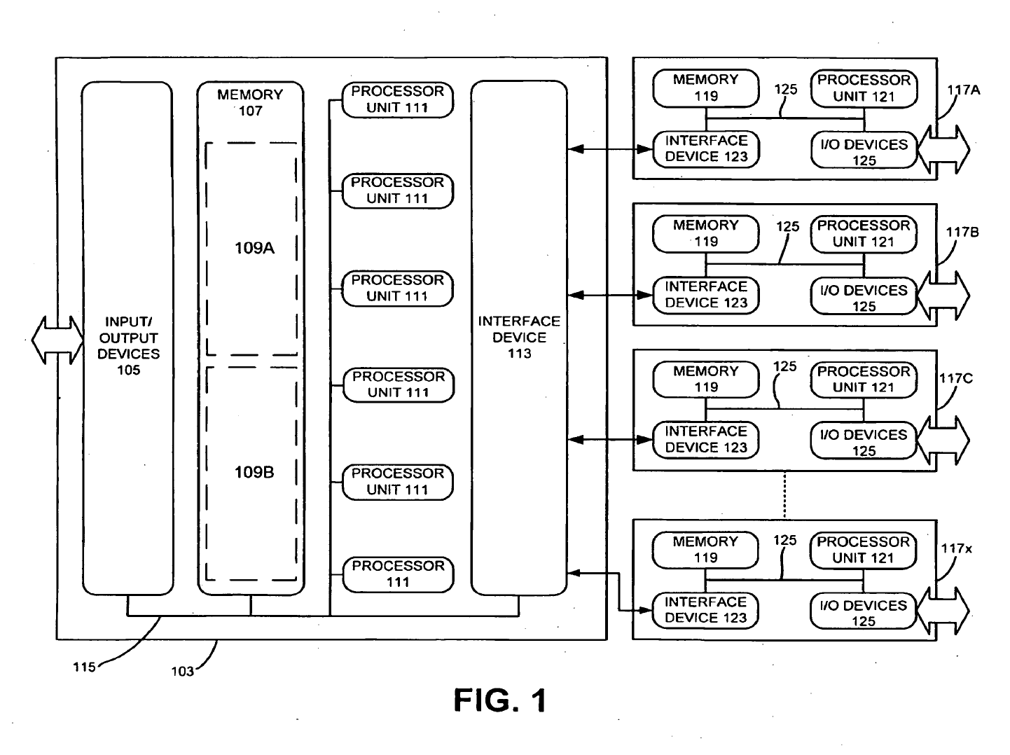

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

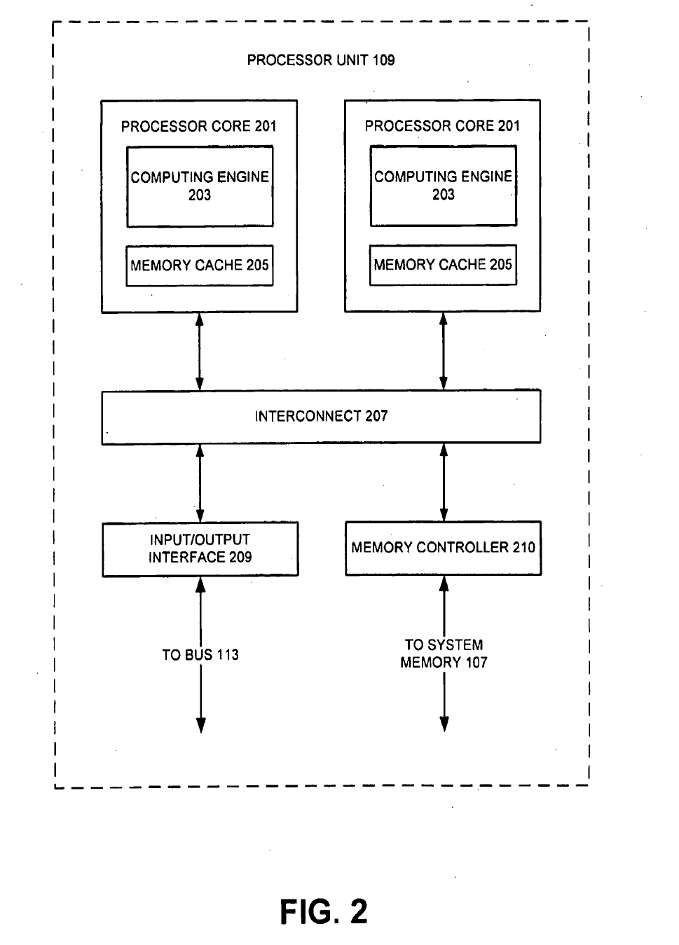

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Incremental Analysis Tool

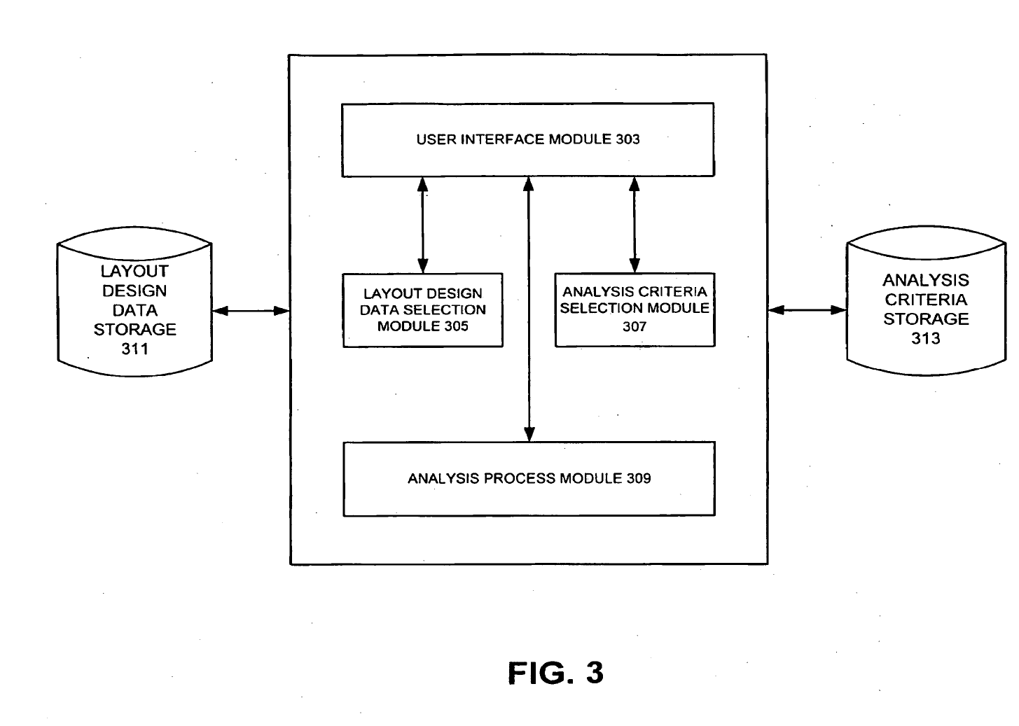

FIG. 3 illustrates an example of an incremental analysis tool 301 that may be implemented according to various examples of the invention. The incremental analysis tool 301 includes a user interface module 303, a layout design data selection module 305, an analysis criteria selection module 307, and an analysis process module 309. As seen in this figure, the incremental analysis tool 301 may operate in conjunction with a layout design data storage 311 and an analysis criteria storage 313.

The user interface module 303 provides a user with one or more user interfaces for controlling the operation of the layout design data selection module 305, the analysis criteria selection module 307, and the analysis process module 309. As used herein, the term “user” refers to any person or persons that may use the incremental analysis tool 301 to analyze and modify a microcircuit design. A user may be, for an example, an original designer of the microcircuit design, or a user at a foundry seeking to, e.g., modify an existing microcircuit design prior to manufacturing a microcircuit from the design. As will be discussed in more detail below, the user interface or interfaces allow a user to instruct the layout design data selection module 305 to determine the layout design data that will be analyzed in an incremental analysis process. Similarly, the user interface or interfaces allow a user to instruct the analysis criteria selection module 307 to determine the analysis criteria used to analyze the selected layout design data in the incremental analysis process.

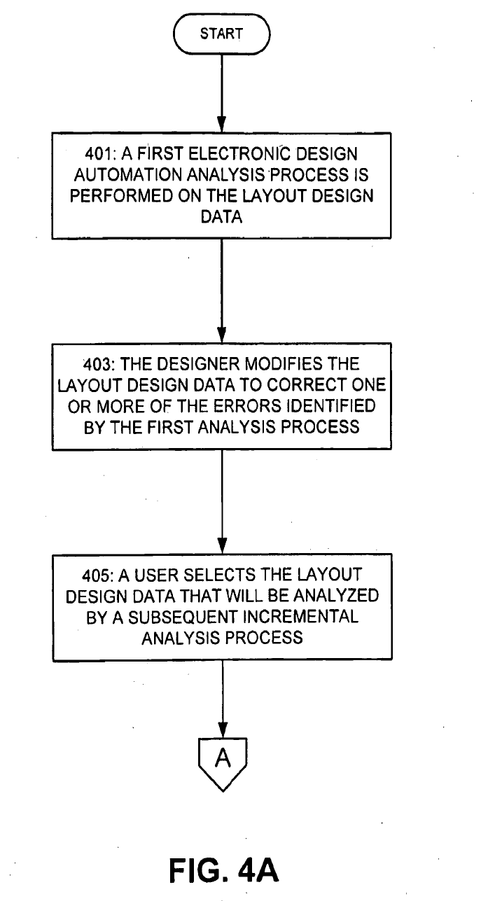

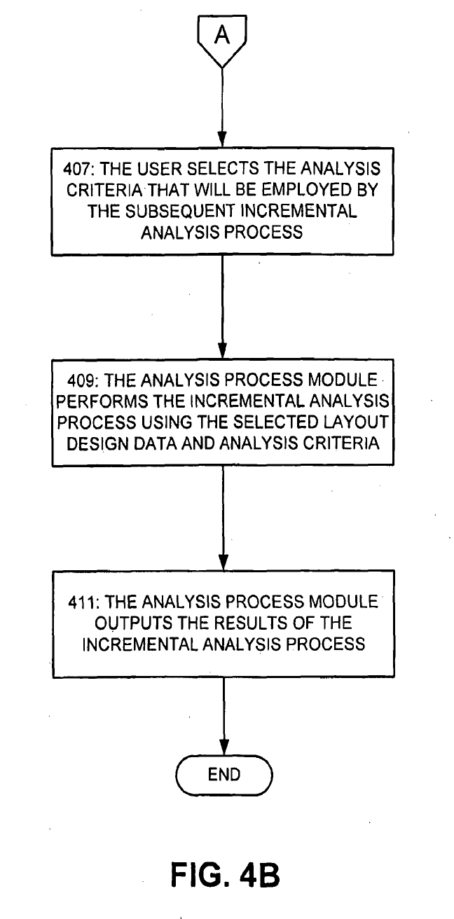

In response to the instructions from the user, the layout design data selection module 305 will select layout design data in the layout design data storage 311, which is then provided to the analysis process module 309. Likewise, in response to instructions from the user, the analysis criteria selection module 307 will select analysis criteria from the analysis criteria storage 313, which is then provided to the analysis process module 309. Using the selected analysis criteria, the analysis process module 309 then will analyze the selected layout design data. The operation of the incremental analysis tool 301 will be discussed in more detail with regard to the flowchart illustrated in FIG. 4.

### Prior Analysis and Correction

In step 401, a first electronic design automation analysis process is performed on the layout design data. The analysis process may be any type of known electronic design automation analysis process, such as a layout-verses-schematic process, a design rule check process, a design-for-manufacturing process, or an optical proximity correction verification process. With various embodiments of the invention, this first analysis process may be performed by the incremental analysis tool 301. With still other embodiments of the invention, however, the first analysis process may be performed by some other analysis tool than the incremental analysis tool 301.

As previously noted, in some instances the first analysis process will make a “complete” analysis of the layout design data. That is, the analysis process will analyze all or a major portion (e.g., an entire layer) of the layout design. With a complete analysis, the analysis process will typically employ a large set of analysis criteria to analyze the layout design data. For example, if the analysis process is a design rule check process, a complete analysis may employ a relatively large list or “deck” of rules with which the layout design data must comply to pass the analysis. A rule deck for a design rule check process may contain rules such as, for example, the minimum distance between metal lines for a metal layer, the maximum length of adjacent parallel lines in a polysilicon layer, the minimum density of structures in another metal layer, etc. These rule decks are compiled based upon the designer's experience and industry knowledge, and are often carefully guarded proprietary secrets.

The analysis process will identify errors detected in the layout design data that need correction. For example, the analysis results of a conventional analysis process may include a map of the design with error markers showing the location of each detected error. In addition, the analysis results may identify the analysis criteria (e.g., the design rule) that the layout design data violated to create the error. Thus, if two lines in a layout design violate a minimum spacing rule, the analysis results may include an error marker marking the offending lines and a text note specifying the minimum spacing rule that was violated. If the analysis process is performed by the incremental analysis tool 301, then the incremental analysis tool 301 tool can store the results of the first analysis process. If the analysis process is performed by a different tool other than the incremental analysis tool 301, then the results of the analysis process may be provided to the incremental analysis tool 301 for subsequent use.

Next, in step 403, the designer modifies the layout design data to correct one or more of the errors identified by the first analysis process. Again, with various embodiments of the invention, the designer will modify the layout design data using the incremental analysis tool 301. For example, the user interface module 303 may provide the designer with access to or the use of one or more layout design data editing tools, such as the Calibre RVE and Calibre Interactive software tools available from Mentor Graphics Corporation of Wilsonville, Oreg. Alternately, the designer may employ one or more separate layout design data editing tools other than the incremental analysis tool 301 to modify the layout design data. Again, if a layout design data editing tool other than the incremental analysis tool 301 is used to modify the layout design data, then the revisions to the layout design data may be provided to the incremental analysis tool 301 for subsequent use.

### Selection of Layout Design Data

In step 405, a user selects the layout design data that will be analyzed by a second, incremental analysis process. More particularly, the user employs one or more user interfaces provided by the user interface module 303 to instruct the layout design data selection module 305 to selects the layout design data that will be analyzed. It should be noted that, as used herein, the term “selects” includes both a directed selection by a user to and a decision by a user not to make a directed selection, but to instead allow the incremental analysis tool 301 to implement a default selection. As previously noted, various embodiments of the invention will allow a user to select the layout design data according to a number of different characteristics.

### Changed Layout Design Data

Some implementations of the invention, for example, may allow a user to select the portions of the layout design data that were changed from a previous version. This selection basis may be particularly useful where the changes made to the layout design data are not readily known to the user. For example, if the layout design data was modified in step 403 by another designer using a layout design data editing tool different from the incremental analysis tool 301, the user may be unaware of the changes made to the layout design data after, e.g., the first analysis process. By instructing the layout design data selection module 305 to identify changes made to an earlier version of the layout design data, the user can ensure that any changes made to the layout design data are analyzed in the second analysis process.

With various embodiments of the invention, the layout design data selection module 305 can identify changes in the layout design data using a variety of techniques. If the changes were made using the incremental analysis tool 301, then the layout design data selection module 305 (or other component of the incremental analysis tool 301) may simply record each change as it is made. The layout design data selection module 305 may, for example, store the changes in a lookup table. Still other implementations of the invention may perform a logical XOR operation on both the current version of the layout design data and the earlier version of the layout design data. As known in the art, such a logical operation will identify differences between the two versions of the layout design data.

If the layout design data is particularly complex or arranged in a hierarchical structure, some implementations may employ a hash table to more quickly identify differences between two versions of the layout design data. As discussed in detail above, layout design data is often organized hierarchically into cells. Each cell may contain either of two different types of design components: other cells and geometric elements (along with various data associated with those geometric elements, such as text data). In order to ensure that two cells in different versions of the layout design data are actually the same, the contents of the cells must be examined to confirm that they are the same. Comparing the geometric element of one cell with every geometrical element of another cell until a match is found (or until it is established that the second cell does not contain a matching geometric element) can be time consuming, however, and the amount of time grows exponentially with the number of geometric elements to be compared. Similarly, comparing the cell instances of one cell with every cell instance in another cell until a match is found (or until it is established that there is not match in the second cell) is time consuming, with the amount of time growing exponentially with the number of instances to be compared.

To reduce the amount of time and computational resources required to compare the contents of one cell with the contents of another cell, various embodiments of the invention will employ a hash operation to sort the design components in two cells before comparison. For example, some implementations of the invention will create a hash table that sorts each of the geometric elements in a cell. Likewise, they will create another hash table that sorts each of the cell instances in the cell. Once the cell's contents are organized into these hash tables, the incremental analysis tool 301 need only compare the contents in one “bucket” of the hash table (i.e., having one index value) for the first cell with the contents of the corresponding “bucket” of the hash table created for a potentially matching second cell.

For example, some implementations of the incremental analysis tool 301 will identify an unprocessed geometric element in a cell. Next, the incremental analysis tool 301 will select some characteristic of the geometric element that can be employed with a hash function to sort the geometric element. For example, with some implementations of the invention, the incremental analysis tool 301 will create a bounding box around the geometric element. As will be appreciated by those of ordinary skill in the art, the use of a bounding box allows the incremental analysis tool 301 to establish an easily-comparable feature for even irregularly-shaped geometric elements. The incremental analysis tool 301 then will select some unique point on the bounding box, such as, e.g., the lower left-hand corner, and apply a hash function to the coordinate value for that point. For example, some embodiments of the invention will create a 64-bit number or “hashing value” by combining the absolute values of the x-coordinate and y-coordinate values of the lower left hand corner of the bounding box for a geometric element, and then apply a hash function to that hashing value.

Various embodiments of the invention may employ any desired type of hash function to the characteristic of the geometric element. Some implementations of the invention, however, may select a hash function based upon the number of geometric elements in the cell that need to be sorted. For example, if a cell has N number of geometric elements, some embodiments of the invention will divide the hashing value by a number S that is the closest prime number to the value of N without exceeding the value of N. Thus, if the cell has 100 geometric elements (i.e., N=100), various embodiments of the invention will determine the value of S=97. The incremental analysis tool 301 will then divide the hashing number for the geometric element by S, and designate the mod of the division to be the index value for that geometric element. These steps then are repeated until each geometric element in the cell has been processed and unique information for the geometric element added as a key or keys to the hash table. Next, each of these steps is repeated for the second cell being compared with the first cell, using the same value of S.

Once a hash table has been created for the geometric elements in each of the cells, the geometric elements in each cell having the same “bucket” or index value can be compared. For example, the hash table for the first cell may have two geometric elements assigned an index value of “3,” while the hash table for the second cell may have three geometric elements assigned an index value of “3.” The first geometric element in the first hash table then need only be compared with the each of the three geometric elements in the second hash table until a match is found (or not found). Similarly, the second geometric element in the first hash table need only be compared with each of the three geometric elements in the second hash table until a match is found (or not found). If the first geometric element in the first hash table matches the first geometric element in the second hash table, and the second geometric element in the first hash table matches the second geometric element in the second hash table, then the third geometric element in the second hash table can be identified as a new geometric element. With various embodiments of the invention, the geometric elements can be compared using one or more keys in the hash table containing information that uniquely identifies its corresponding geometric element.

Various embodiments of the invention may employ any unique characteristics to compare geometric elements sharing an index value. Some implementations of the invention, for example, may compare the coordinate values of each corner of the geometric elements to confirm that they are, in fact, identical. First, if the number of coordinate values is different (e.g., one geometric element has 6 corners, while the other geometric element has 8 corners), then the two geometric elements can immediately be identified as different. In some instances, the coordinate values for two geometric elements will be ordered differently, even though the geometric elements are identical. For example, the coordinate values for the corners of one geometric element may be ordered in a clockwise manner, while the coordinate values for the corners of the other geometric element may be ordered in a counter-clockwise manner. Accordingly, various examples of the invention may begin comparing the coordinate values in the same order (e.g., comparing the coordinate values for the first corner of one geometric element to the coordinate values for the first corner of other geometric element). If the coordinate values do not match, then the incremental analysis tool 301 will reverse the order of comparison of the coordinate values (e.g., comparing the coordinate values for the first corner of one geometric element to the coordinate values for the last corner of other geometric element, comparing the coordinate values for the second corner of one geometric element to the coordinate values for the next-to-last corner of other geometric element, etc.). In this manner, the coordinate values for the geometric elements can be quickly compared without using a more computationally intensive comparison algorithm.

With various examples of the invention, the cell instances occurring in two cells can be sorted and compared in the same manner as the geometric elements. Because cell instances will include a particular coordinate location for placement of the cell, however, the use of a bounding box to determine a hashing value can be omitted. Instead, the coordinate values for the placement location of the cell can be used instead of the coordinate value of the lower-left corner of a bounding box, as described above. Once the cell instances and geometric elements of two cells have been sorted and compared, the unmatched cells instances in the first cell can be identified as deleted cell instances, while the unmatched cells instances in the second cell can be identified as added cell instances. Similarly, unmatched geometric elements in the first cell can be identified as deleted geometric elements, while unmatched geometric elements in the second cell can be identified as added geometric elements. In this manner, changes made to the layout design data between different versions can quickly and efficiently be identified.

It should be noted that, while various implementations of this hash-based comparison technique can be employed to perform an incremental analysis as discussed herein, these implementations also may be used for any operation or process where different versions of layout design data need to be compared. For example, some implementations of this hash-based comparison technique can be employed to identify a particular portion (such as a proprietary circuit design) in a larger set of layout design data.

### Errors in Layout Design Data

Some implementations of the invention also may allow a user to select the portions of the layout design data that failed a previous analysis process. Thus, if the results from the first analysis process are available to the incremental analysis tool 301, then the user can instruct the layout design data selection module 305 to select one or more errors identified in those previous results. As previously noted, the results of an analysis process typically will include error markers marking errors (i.e., portions of the layout design data that failed one or more of the analysis criterion) in the design. If these error markers are available to the incremental analysis tool 301, then the layout design data selection module 305 can use the markers to the select portions of the layout design data identified by the markers.

With some examples of the invention, a user may select each of the identified errors in the layout design data. That is, the user may employ a user interface to instruct the layout design data selection module 305 to identify each location in the layout design data identified by an error marker. With still other embodiments of the invention, however, a user may alternately or additionally be allowed to select only errors of a specified type. For example, a user may instruct the layout design data selection module 305 to identify only those errors that violate a minimum metal layer spacing rule. In some implementations, a user may select a particular category of error by selecting an error in that category from the results of a previous analysis process. The layout design data selection module 305 will then identify instances of that error type in the layout design data.

Still other implementations of the invention may alternately or additionally allow a user to select only those errors in the layout design data that have been “fixed” (i.e., where the layout design data has been revised to correct or otherwise remove the identified error). More particularly, some layout design data editing tools may discriminate “fixed” errors from “unfixed” errors. These layout design data editing tools may, for example, change the value of a flag associated with an error marker when a designer indicates that the error has been fixed, store the locations of fixed errors in a lookup table, etc. The layout design data selection module 305 can then use this information to identify and select those errors that purportedly have been fixed. This feature may be useful where a user only wants to confirm that specific errors have been removed without spending a large amount of time analyzing other portions of the layout design data, particularly if the user knows that many errors have not yet been fixed.

Selecting layout design data based upon previously-identified errors may be useful where the designer knows that changes made to correct or “fix” the errors will usually be local to the error marker identifying the error. If the changes are local to the error marker, then analyzing the layout design data identified by an error marker thus will typically ensure that the changes are analyzed as well.

### User-Defined Layout Design Data

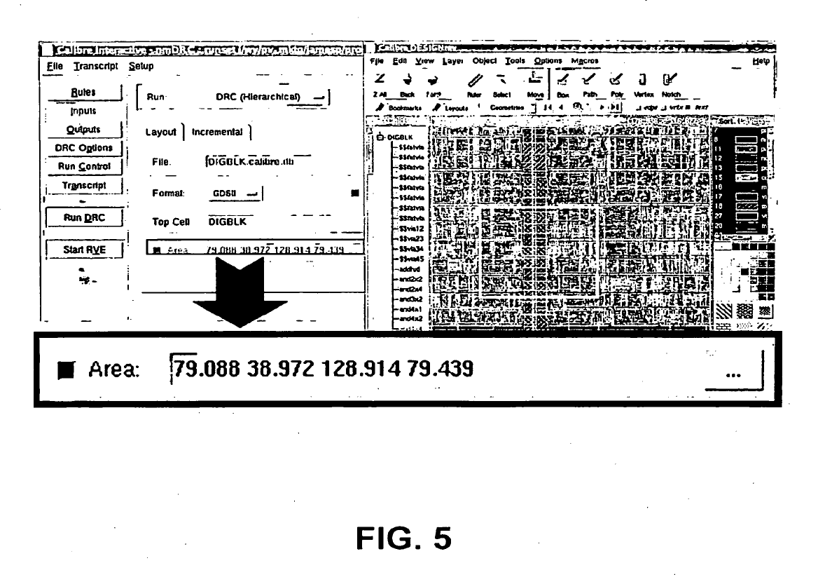

Some implementations of the invention may alternately or additionally allow a user to manually specify one or more portions of the layout design data for analysis by a second, incremental analysis process. For example, the user interface module 303 may provide the user with a map of the design, from which the user can select locations in the design for analysis. In response, the layout design data selection module 305 will select the portions of the layout design data corresponding to the locations chosen by the user. For example, as illustrated in FIG. 5, the user may employ a user interface provided by the user interface module 303 to specify the coordinates of an area in the layout design data. The layout design data selection module 305 will then select the layout design data within the proscribed area.

### Halos

With various embodiments of the invention, the layout design data selection module 305 will create a “halo” region around the selected layout design data. The layout design data within this halo region is then added to the selected layout design data for analysis by an incremental analysis process. With some embodiments of the invention, the layout design data selection module 305 will create a bounding box around the selected layout design. The layout design data selection module 305 will then designate a halo region based upon the perimeter of the bounding box.

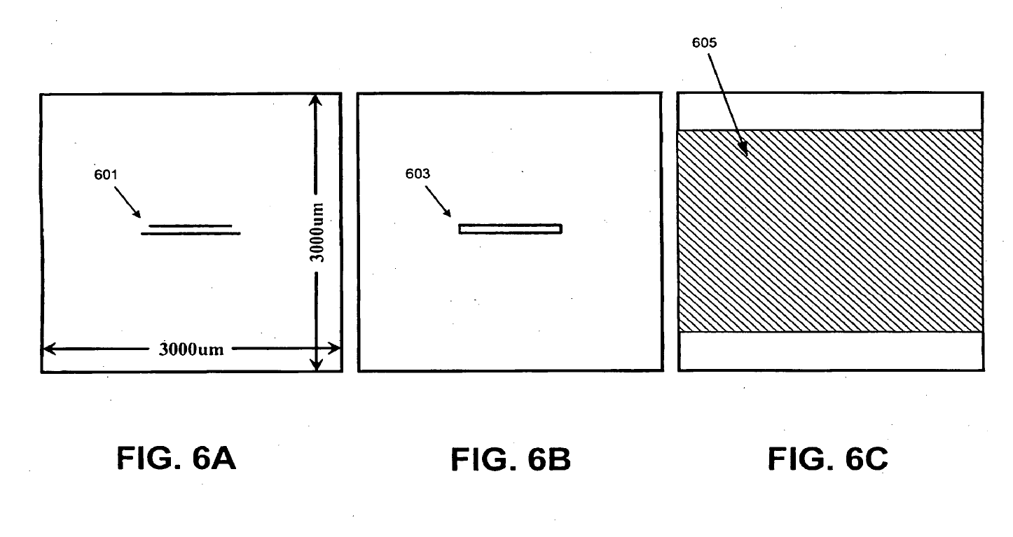

For example, FIG. 6A illustrates a pair of error markers 601 in a layout design. The error markers 601 may indicate, e.g., the occurrence of two adjacent lines that are closer than a minimum spacing width. As previously noted, the selected layout design data may be data identified by an error marker like error marker 601. In response to the selection of the error identified by the error marker 601, the layout design data selection module 305 will create a bounding box 603 bounding the error marker 601, as shown in FIG. 6B. Next, the layout design data selection module 305 will create the halo region 605, as shown in FIG. 6C, based upon the perimeter of the bounding box 605. In the illustrated example, the layout design data selection module 305 creates the bounding box 603 to be 1000 μm×1 μm. Next, the layout design data selection module 305 will designate the halo region as some multiple of the longer of the length or width of the bounding box 603 (i.e., 1000 μm). With the illustrated implementation of the invention, the layout design data selection module 305 designates each side of the halo region to be three times the length of the bounding box 603, e.g., 3000 μm×3000 μm. Of course, still other implementations of the inventions may use different multiples of the longest side of the bounding box, or still other algorithms to determine the halo region altogether.

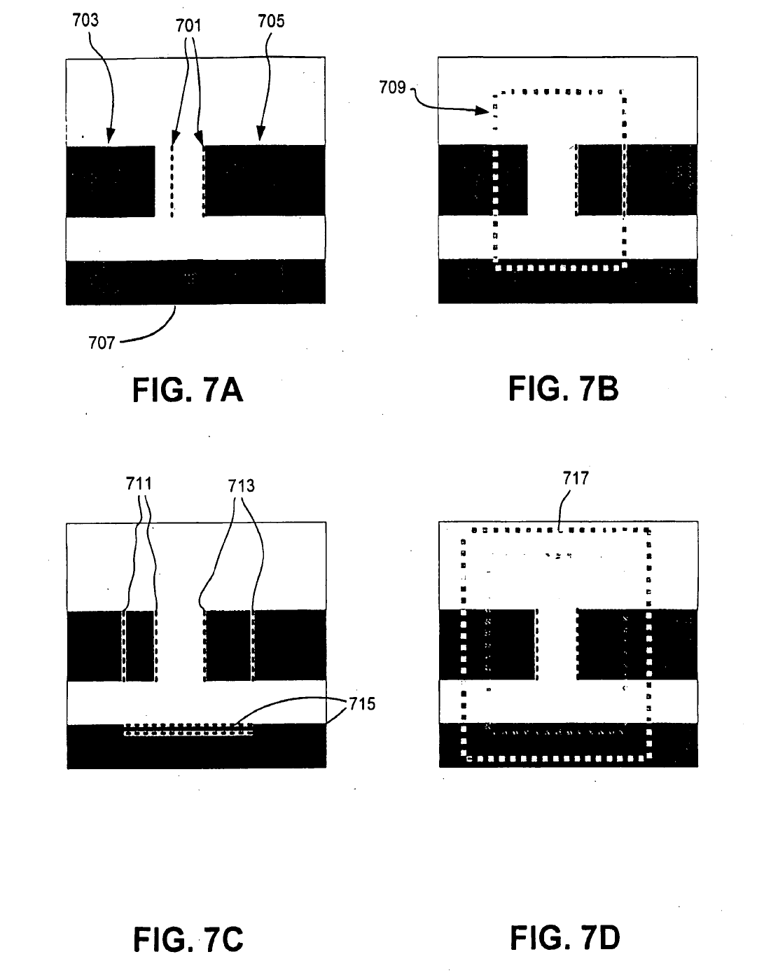

Various implementations of the invention may alternately or additionally allow a user to select the size and/or shape of the halo region. This may be useful to, e.g., prevent the incremental analysis process from detecting a false error. For example, FIG. 7A illustrates error markers 701 located between a first geometric element 703 and a second geometric element 705, which are both in turn adjacent to a third geometric element 707. If the layout design data selection module 305 create the halo region 709, as shown in FIG. 7B, then the halo region 709 may inadvertently enclose too little of the geometric element 703-707. As a result, the next incremental analysis process may register errors for violating a minimum width requirement (as indicated by error markers 711-715 in FIG. 7C), even though each of geometric elements 703-707, in fact, complies with the minimum width requirement. By designating a larger halo region 717 (as shown in FIG. 7D), the user can ensure that the inaccurate minimum width requirement violations are not registered by a subsequent incremental analysis process.

### Combinations and Other Selection Criteria

While specific individual techniques for selecting layout design data for incremental analysis have been described above, it should be appreciated that various implementations of the invention of the invention may allow a user to select layout design data using a combination of these techniques. More particularly, some implementations of the invention may allow a user to select the set of layout design data designated by any of two or more of these techniques (i.e., as with a logical OR operation), allow a user to select only the overlap of layout design data designated by any two or more of these techniques (i.e., as with a logical AND operation), or a combination of both. For example, some implementations of the invention of the invention may allow a user to first select the errors identified by an earlier analysis process, and then further select a subset of these areas that are encompassed within a user-defined area. Still other implementations may alternately or additionally allow the user to select both the errors identified by an earlier analysis process and the changes in the layout design data from an earlier version.

It also should be noted that, in addition to the selection techniques described above, various implementations of the invention may allow a user to select data using still other techniques. For examples, some embodiments of the incremental analysis tool 301 may allow a user to select the errors or changes occurring in only a specific layer of the layout design data, to select changes made by a particular designer, to select errors identified by a specific iteration of an analysis process, or any other characteristic useful for discrimination portions of the layout design data for incremental analysis.

### Selection of Analysis Criteria

Returning now to FIG. 4, in step 407 the user selects the analysis criteria that will be employed by a second, incremental analysis process. As previously noted, various implementations of the invention will alternately or additionally allow a user to select the analysis criteria that will be used to analyze layout design data in an incremental analysis process. For example, with some implementations of the invention, a user can employ one or more user interfaces provided by the user interface module 303 to select the analysis criteria for analyzing selected layout design data. The analysis criteria selection module 307 will then implement the user's selection for an incremental analysis process.

Various implementations of the invention may be employed after a user has executed a “complete” analysis of an entire set of layout design data. This complete analysis will typically use a large number of analysis criteria to analyze the layout design data. For example, a rule deck for a design rule check analysis process may include hundreds of rules, requiring a large amount of computer processing time and resources to implement. Various implementations of the invention will allow the user to designate an entire set of analysis criteria, such as those used in a previous “complete” analysis of the layout design data, for use in a subsequent incremental analysis process. Some implementations of the invention, however, will allow a user to select a subset of a larger set of available analysis criteria for use in an incremental analysis process.

For example, some implementations of the invention allow a user to specify that an incremental analysis process employ only analysis criteria applicable to the layout design data being analyzed in the incremental analysis process. Thus, if the layout design data being analyzed contains only data for a particular metal layer in the design (e.g., METAL LAYER 1), then the analysis criteria selection module 307 will only select analysis criteria applicable to that data. The analysis criteria selection module 307 will not select analysis criteria relating to e.g., layout design data for a polysilicon layer in the design. With some implementations of the invention, the analysis criteria selection module 307 will not even select analysis criteria specifically relating to other metal layers in the layout design (e.g., METAL LAYER 1, FILL LAYER 1, etc.).

Some implementations of the invention may alternately or additionally allow a user to specify that an incremental analysis process employ only analysis criteria that was failed in a previous analysis process. For example, if the incremental analysis is analyzing the results produced by an earlier analysis process, then the results may specify the analysis criterion failed by each identified error. In response, the analysis criteria selection module 307 may identify the particular errors selected for the incremental analysis, determine the analysis criterion associated with each selected error, and select those analysis criteria for use by the incremental analysis. With this feature, a user can avoid having the incremental analysis process perform evaluations that are likely to be unnecessary.

Still further, some implementations of the invention may allow a user to manually select a subset of analysis criteria from a larger set. These implementations of the invention may actively require a user to select which specific criterion will be employed in the incremental analysis process, passively apply every criterion in the set of analysis criteria that has not been specifically waived by the user, or some combination of both.

It should be noted that some embodiments of the invention may automatically restrict some analysis criteria from being employed by the incremental analysis process. For example, if the incremental analysis process is a design rule check analysis process, the analysis criteria selection module 307 may prevent the incremental analysis process from using connectivity checks. Because the incremental analysis process is likely to analyze only a portion of the total layout design data, the analyzed portion is unlikely to contain enough data to accurately perform this type of check. That is, the analyzed portion is unlikely to contain all of the geometric elements required to establish a continuous connection between a target device and a power or ground connection point. Similarly, the analysis criteria selection module 307 may automatically exclude other “chip level” analysis criteria that require a significant portion of the layout design data to properly evaluation, such as fill density checks.

As with the selection of layout design data, various implementations of the invention may allow a user to combine two or more of the selection techniques for selecting the analysis criteria. For example, some embodiments of the analysis criteria selection module 307 may allow a user to select both the analysis criteria failed by errors in the selected layout design data and additional analysis criteria manually specified by the user. Still other examples of the invention may alternately or additionally allow a user to select only the analysis criteria applicable to the selected layout design data, and then further manually select a particular subset of this limited analysis criteria.

### Incremental Analysis

After the user has selected the layout design data and/or the analysis criteria to be used in the incremental analysis process, then the analysis process module 309 performs the incremental analysis process using these inputs in step 409. Then, in step 411, the analysis process module 309 outputs the results of the incremental analysis process to the user. The results may be in any desired format.

As previously noted, an incremental analysis process according to various examples of the invention may be simply one iteration of an analysis process among many. Accordingly, each of steps 403-409 may be repeated one or more times, until the layout design data is deemed satisfactory. Still further, the step 403 of modifying the layout design data before analysis can be omitted where desired. For example, a user may wish to run a check of one portion of the layout design data against a first set of analysis criteria, and then run a check of a second portion of the layout design data against a second set of analysis criteria before modifying any of the layout design data.

Some implementations may allow a user to repeat one or more of steps 403-409 before a previous incremental analysis process has completed its analysis. For example, some embodiments of the analysis process module 309 may begin returning analysis results to the user before an incremental analysis process has completed its analysis. In response, a user may, e.g., correct one or more errors identified by the incremental analysis process, and initiate a second incremental analysis process to confirm that the errors have been fixed. As discussed in detail above, the user may employ a user interface to select only specific instances of the reported errors for analysis in the second incremental analysis process, only the analysis criteria failed by the reported errors for use by the second incremental analysis process, or a combination both (including a combination where only the analysis criteria failed by the selected reported errors is selected). In this manner, a user can efficiently employ a computing system, such as a distributed computing system, to confirm that correction of detected errors even before a longer, more time-consuming analysis process is completed.

It also should be noted that some implementations of the invention may omit the layout design data selection module 305, while still other implementations of the invention may omit the analysis criteria selection module 307. That is, some implementations of the invention may allow the user to select the analysis criteria to be used in an incremental analysis process, but not select the layout design data. Alternately, some implementations of the invention may allow the user to select the layout design data, but not select the analysis criteria to be used in an incremental analysis process.

### User Interfaces

### Initial Flow Selection User Interface

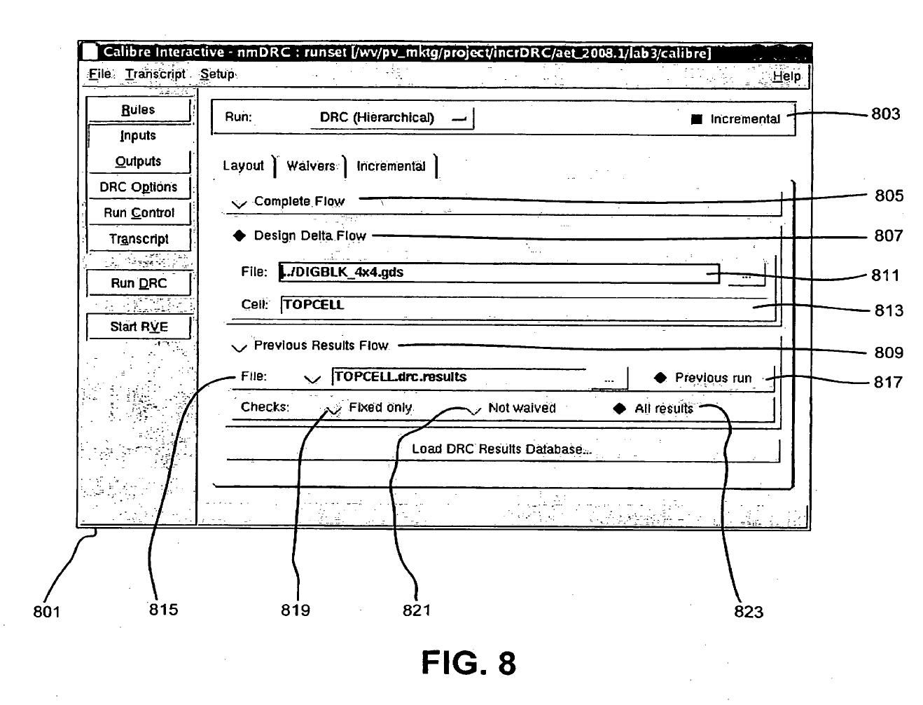

FIG. 8 illustrates an example of a user interface 801 that may be provided according to various examples of the invention. As seen in this figure, the user interface 801 provides an incremental analysis process radio control 803 that allows a user to select to perform an incremental analysis process on layout design data. (In the illustrated embodiment, the analysis process is a design rule check.) The user interface 801 also includes a “complete flow” radio control 805, a “design delta” radio control 807, and a “previous results flow” radio control 809. With the illustrated examples of the invention, each one of these controls is mutually exclusive (that is, selecting one control will automatically deselect the other two controls).

If the user selects the “complete flow” radio control 805, then the analysis process module 309 will perform a “complete” analysis process on layout design data, as discussed in detail above. (Some implementations of the invention may provide a further user interface or control allowing the user to select the layout design data to be analyzed.) If, however, the user selects the “design delta” radio control 807, then the user interface module 303 enables the “file” field control 811 and the “cell” field control 813. Employing these field controls, a user designates a file containing the layout design data and the cell of that layout design data to be analyzed using an incremental analysis process, as discussed in detail above. More particularly, the analysis process module 309 will perform an incremental analysis process on the data in the specified layout design that has changed from an earlier version of the specified layout design data.

If the user alternately selects the “previous results flow” radio control 809, the user interface module 303 will similarly enable the file field control 815 and the “previous run” radio control 817. The user interface module 303 also will enable the “fixed only” radio control 819, the “not waived” radio control 821, and the “all results” radio control 823. The user can employ the file field control 815 to designate a file containing results of a previous analysis process. Alternately, if the user simply wants to analyze results that have just been provided by the analysis process module 309, the user can select the “previous run” radio control 817. Once the source of the results have been specified, the user can then employ the radio controls 819-823 to designate which results will be analyzed, as discussed in detail above. More particularly, if the user wants all of the layout design data for which results were generated in the previous incremental analysis process, then the user selects the “all results” radio control 823. If, however, the user only wants to analyze the errors that were purportedly fixed since the results were obtained, then the user selects the “fixed only” radio control 819. If the user only wants to analyze specific portions of the layout design data for which results were generated in the previous incremental analysis process, then the user can waive any layout design portions that the user does not want to analyze, and select the not waived” radio control 821.

### Validation Run User Interface

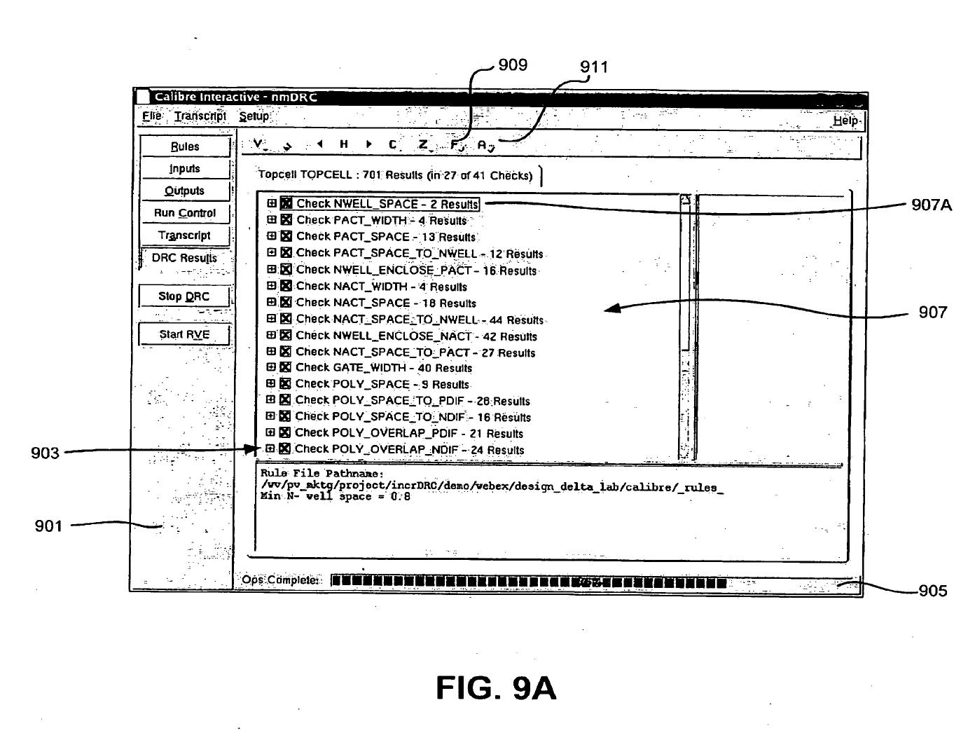

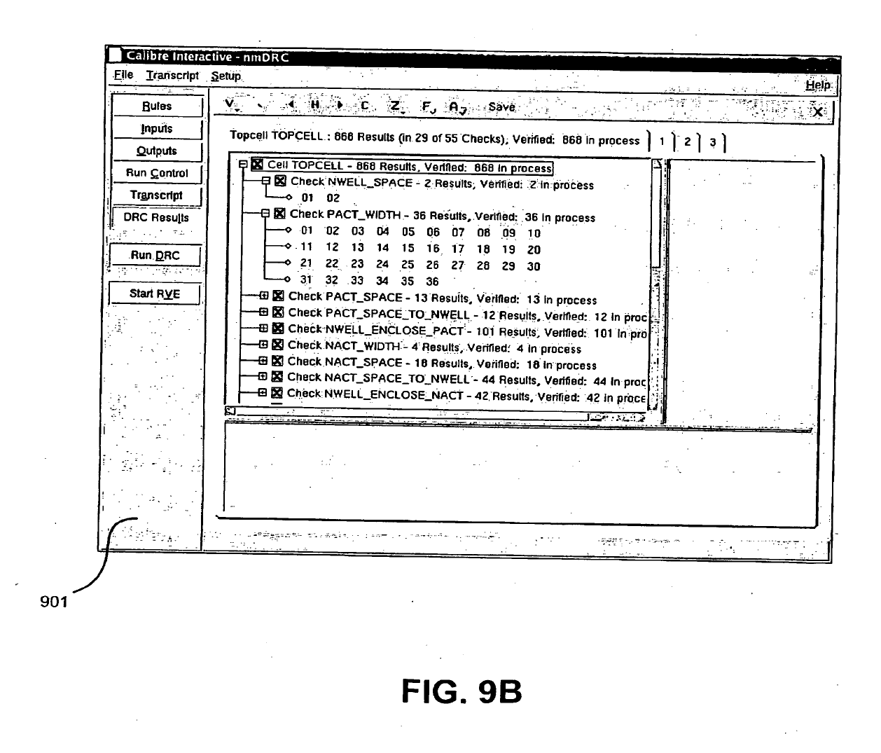

Once the user has initiated the incremental analysis process based upon the selections submitted via the user interface 801, various embodiments of the invention may provide the user with a second user interface showing the real-time results of the ongoing analysis process (incremental and/or complete). For example, some implementations of the invention may provide the user with the user interface 901 illustrated in FIG. 9. As seen in this figure, the user interface 901 includes a result display portion 903 and an analysis process status display portion 905. The result display portion 903 displays the results 907 that have been produced by the ongoing analysis process for each of the analysis criteria. As seen in this figure, the results 907 are displayed as the number of portions of the layout design data that failed an associated analysis criterion.

As discussed in detail above, a user may employ the user interface 901 to initiate incremental analysis process on the portions of the layout design data associated with one or more of the results 907, even while the pervious analysis process is ongoing. For example, a user may modify portions of the layout design data relating to one or more of the results 907 (e.g., results 907A). If the user wishes to perform an incremental analysis on an area related to this result, then the use can select the “incremental area” button control 911. With various examples of the invention, the user interface module 303 will provide a user interface (such as the user interface illustrated in FIG. 5 allowing the user to designate a desired portion or portions of the layout design data for a subsequent incremental analysis (such as the user interface illustrated in FIG. 5). If, however, the user wishes to repeat the incremental analysis process on the portions of the layout design data associated with the result 907A, then the user can select that result, and then activate the “start validation run” button control 909.

In response to the activation of the “start validation run” button control 909, then the incremental tool 301 will start a new incremental analysis process on the portion of the layout design data corresponding to the selected result. Further, the user interface 901 may update the result display portion 903 to show the new results provided by the new incremental analysis process. Some implementations of the invention may additionally allow a user to view the each new result associated with a particular analysis criterion, as illustrated in FIG. 9B. Various embodiments of the invention can provide the new results as desired. For example, some implementations of the invention may highlight the results with yellow if the subsequent incremental analysis process is still operating on their associated portions of the layout design data, green if the portions of the layout design data have passed the analysis criterion for the subsequent incremental analysis process, red if the portions of the layout design data have again failed the analysis criterion in the subsequent incremental analysis process, and orange if the subsequent incremental analysis process returned new results for those portions of the layout design data.

Of course, it should be appreciated that still other type of user interfaces can be employed to implement various embodiments of the invention as described in detail above.

### CONCLUSION

While specification embodiments of the invention have been shown and described in detail above to illustrate the principles of the invention, it will be understood that the invention may be otherwise embodied with departing from the invention. Thus, while the invention has been described with respect to specific examples including presently preferred modes of carrying out the invention, those of ordinary skill in the art will appreciate that there are numerous variations and permutations of the above described systems and techniques that fall within the spirit and scope of the invention as set forth in the appended claims.

1. A method of correcting layout design data, comprising.
performing a first analysis process on layout design data;
identifying a portion of the layout design data; and
performing a second analysis process on the identified portion of the layout design data.

2. The method recited in claim 1, wherein identifying a portion of the layout design data includes identifying data modified by correction information.

3. The method recited in claim 2, wherein identifying data modified by correction information includes:
employing a hash table to compare a first database containing an initial version of the layout design data with a second database contain a revised version of the layout including the new data provided in the correction information.

4. The method recited in claim 1, wherein the error analysis is a design rule check analysis.

5. The method recited in claim 1, wherein the error analysis is a design-for-manufacturing analysis.

6. The method recited in claim 1, wherein the second set of analysis criteria is a subset of the first set of analysis criteria.

7. The method recited in claim 1, further comprising initiating the second error analysis on the identified portion of the layout design while the first error analysis continues to be performed on a second portion of the layout design.

8. The method recited in claim 1, further comprising:
identifying a second portion of the layout design data that includes new data provided in the correction information; and
performing a third error analysis on the identified second portion of the layout design data.

9. The method recited in claim 8, further comprising initiating the third error analysis on the identified second portion of the layout design while the second error analysis continues to be performed on the identified first portion of the layout design and the first error analysis continues to be performed on a third portion of the layout design.

10. A computer-readable medium, having stored thereon computer-readable instructions for performing the steps recited in claim 1.

11. A method of correcting layout design data, comprising.
performing a first analysis process on layout design data using a first set of analysis criteria;
selecting a second set of analysis criteria different from the first set of analysis criteria; and
performing a second analysis process on the identified portion of the layout design data using the second set of analysis criteria.

12. The method recited in claim 11, wherein the second set of analysis criteria does not entirely overlap with the first set of analysis criteria.

13. The method recited in claim 11, further comprising:
identifying one or more portions of the layout design data; and
performing a second analysis process on only the identified portions of the layout design data.

14. A computer-readable medium, having stored thereon computer-readable instructions for performing the steps recited in claim 11.

15. A user interface system, comprising:
a first display portion displaying a status of an ongoing layout design data analysis process; and
a second display portion displaying results of the ongoing layout design data analysis process before the ongoing layout design data analysis is completed.

16. The user interface system recited in claim 15, further comprising one or more controls allowing a user to initiate a second layout design data analysis process on layout design data corresponding to one or more of the results displayed in the second display portion.

17. The method recited in claim 15, comprising one or more controls allowing a user to initiate a second layout design data analysis process on layout design data corresponding to one or more of the results displayed in the second display portion before the first layout design data analysis process is completed.

18. A computer-readable medium, having stored thereon computer-readable instructions for performing the steps recited in claim 15.

19. An incremental layout design data analysis tool, comprising:
a layout design data selection module configured to determine portions of a set of layout design data to be analyzed in an incremental analysis process;
an analysis process module configured to perform an analysis process on the portions of the set of layout design data determined by the layout design data selection module; and
a user interface module configured to provide a user with one or more user interfaces for controlling the operation of the layout design data selection module.

20. The apparatus recited in claim 19, further comprising an analysis criteria selection module configured to determine a subset of available analysis criteria to be employed by the analysis process module to analyze the selected layout design data in the incremental analysis process.

21. An incremental layout design data analysis tool, comprising:
an analysis criteria selection module configured to determine a subset of available analysis criteria to be employed in an incremental analysis process;
an analysis process module configured to perform an analysis process on layout design data using the analysis criteria determined by the analysis criteria selection module; and
a user interface module configured to provide a user with one or more user interfaces for controlling the operation of the analysis criteria selection module.

22. A method of comparing layout design data, comprising:
identifying design components of a first set of layout design data;
using a hash function to create an index value for each of the identified design components in the first set of layout design data;
identifying design components of a second set of layout design data;
using the hash function to create an index value for each of the identified design components in the second set of layout design data; and
comparing the identified design components in the first set of layout design data with the identified design components in the second set of layout design data that share a same index value.

23. A computer-readable medium, having stored thereon computer-readable instructions for performing the steps recited in claims 22.
